(19) United States
(12) Patent Application Publication
(10) Pub. No.: US 2009/0114730 A1
(43) Pub. Date: May 7, 2009

(54) SELF CHECKOUT TERMINAL

(75) Inventor: Takeshi Tashiro, Tokyo (JP)

Correspondence Address: AMIN, TUROCY & CALVIN, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/257,090

(22) Filed: Oct. 23, 2008

(30) Foreign Application Priority Data
Nov. 6, 2007 (JP) 2007-288575

(51) Int. Cl. G07G 1/00; G01G 9/00

(52) U.S. Cl. 235/7 A

(57) ABSTRACT

A weighting unit having a low height and a settlement unit having a high height are arranged alongside a register unit. The weighting unit and settlement unit are arranged in the back viewed from a user. A weighting device for weight checking has a weighting base on which items whose code symbols have been read by a scanner of the register unit are mounted, and is contained in the weighting unit. A coin dispenser module and a bill dispenser module, which are vertical recycle type, are arranged alongside one another in the settlement unit. A front panel and a front door are provided to the front face of the settlement unit without interfering with a bagging frame which defines an item mounting space and which is attached to the weighting base. The front panel is pivotally openable and closable and the front door are openable and closable.

### CROSS REFERENCE TO RELATED APPLICATION

The present application is based on Japanese Priority Document P2007-288575 filed on Nov. 6, 2007, the content of which is incorporated herein by reference.

### BACKGROUND OF THE INVENTION

1. Field of the Invention

The present invention relates to a self checkout terminal for realizing a self checkout by a customer.

2. Discussion of the Background

In recent years, a self checkout terminal for realizing a self checkout by a customer is being developed (see Japanese Unexamined Patent Publication No. Hei 10(1998)-069574). The self checkout terminal arranges various user interfaces for sales data processing, where operations by the customer, information provision to the customer, and receipt issue to the customer can be done. The various user interfaces include an item code reading section such as a barcode reader, a display section for display information, an input section for inputting information, a settlement section such as an ATM or a coin/bill dispenser module, and a receipt printer.

In the self checkout terminal, in order to prevent misbehavior, only items whose item codes have been read by the item code reading section, namely, purchased items which are targets of sales data processing, need to be taken out by the customer. As disclosed in Japanese Unexamined Patent Publication No. Hei 9(1997)-245251, weights of items whose item codes have been read are checked to prevent misbehavior. In this technique for checking weights, weight data of an item whose item code has been read in the item code reading section is obtained from an item data file in accordance with the read code, a weight of the item is measured, and it is determined whether the weight data matches the measured weight.

When a self checkout terminal is manufactured, high operability and miniaturization of the whole device need to be achieved.

For example, the arrangement of a self checkout terminal disclosed in Japanese Unexamined Patent Publication No. Hei 10(1998)-06957 is as follows. Around a block of an ATM having function keys and a display for providing various pieces of information to the user, a storage section for item bags for storing items to be purchased is arranged in front of the block of the ATM, a block having a scanner is arranged to left side of the storage section, and a block having a coin dispenser module is arranged to the right of the having the scanner. The user stands in front of the scanner, and makes barcodes of items read by the scanner, and stores the items whose barcodes have been read into an item bag. In this case, the user operates the function keys in accordance with the content of the display if necessary. The eyes and hands move left and right. Additionally, the storage of the items into the item bag does not relate to the operations of the function keys, causing inconvenience. Since the positions of the display and coin dispenser module are offset left and right, the eyes and hands move left and right in case of settlement. The self checkout terminal disclosed in Japanese Unexamined Patent Publication No. Hei 10(1998)-069574 does not have high operability.

In the self checkout terminal disclosed in Japanese Unexamined Patent Publication No. Hei 10(1998)-069574, the storage section for item bags is arranged in front of the ATM having the display, and the scanner and coin dispenser module 24 are arranged to the both sides of the ATM respectively, so that the whole of the device is made large. The weight checking disclosed in Japanese Unexamined Patent Publication No. Hei 9(1997)-245251 needs a weighting device. When such a weighting device is added to the self checkout terminal disclosed in Japanese Unexamined Patent Publication No. Hei 10(1998)-069574, the whole device is made far larger.

From the example of the self checkout terminal disclosed in Japanese Unexamined Patent Publication No. Hei 10(1998)-069574, the high operability and downsizing of the whole device has not been achieved. On the other hand, the self checkout terminal disclosed in Japanese Unexamined Patent Publication No. Hei 10(1998)-069574 is just one example. Self checkout terminals in the past other than the self checkout terminal disclosed in Japanese Unexamined Patent Publication No. Hei 10(1998)-069574 also does not achieve both high operability and downsizing of the whole device.

### SUMMARY OF THE INVENTION

Accordingly, an object of the present invention is to achieve high operability and downsizing of the whole device.

A novel self checkout terminal of the present invention includes a register unit having a scanner that optically reads a code symbol of an item and a display having a touch panel, a weighting unit having a smaller height and depth than those of the register unit, and being able to be arranged alongside the register unit, and a settlement unit having the same width as the weighting unit and being higher than the weighting unit, and being able to be arranged alongside the register unit behind the weighting unit. The weighting unit has a weighting device for checking a weight. A weighting base is arranged to the top surface of the weighting unit. An item whose code symbol has been read by the scanner is mounted on the weighting base. The weighting device secures an item mounting space in which the item packed in a bag is arranged. The settlement unit has a coin dispenser module and a bill dispenser module arranged alongside one another. These devices are a vertical recycle type. The self checkout terminal of the present invention has a bagging frame, front panel, and front door. The bagging frame attached to the weighting base of the weighting unit, and has a pair of hook portions opposed to one another to keep the item open by hooking a pair of handles of an item bag storing the item whose code symbol has been read. The hook portions defines the item mounting space between the hook portions. The front panel is attached to a position having a height that does not interfere with the bagging frame in front of the settlement unit. The front panel is pivotally openable and closable about the vertical axis. The front panel has communication openings respectively communicating with a coin inlet and a coin outlet of the coin dispenser module and with a bill inlet and a bill outlet of the bill dispenser module. The front panel exposes the coin dispenser module and the bill dispenser module to the outside when the front panel is opened. The front door is provided to a lower position of the front panel on the front face of the settlement unit without interfering with the bagging frame. The front door is openable and closable. The front door exposes at least one of the coin dispenser module and bill dispenser module when the front door is opened.

A method for installing the self checkout terminal of the present invention includes a step for installing the register unit, a step for installing, alongside the register unit, the weighting unit having a smaller height and depth than those of the register unit, and a step for installing the settlement unit having the same width as the weighting unit and being higher than the weighting unit, alongside the register unit behind the weighting unit.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a perspective view showing a self check-out terminal;

FIG. 2 is a perspective view showing a register unit;

FIG. 3 is a perspective view showing a weighting unit and a settlement unit;

FIG. 4 is a perspective view of the self checkout terminal when the front panel and the front door of the settlement unit are opened;

FIG. 5 is a perspective view of the self checkout terminal when only the front panel of the settlement unit is opened;

FIG. 6 is an enlarged perspective view showing the process where the front door of the settlement unit is opening or closing;

FIGS. 7A to 7E show the process from the state in which the front door of the settlement unit is closed as shown in FIG. 7A to the state in which the front door of the settlement unit is opened as shown in FIG. 7E;

FIG. 8 is a front view showing shapes of retention pins and hook pins forming part of a vertical motion structure and supporting structure provided to a portion to which the front door of the settlement unit is attached;

FIG. 9 is an enlarged side view showing the vertical motion structure of the front door;

FIG. 10 is a side view showing the supporting structure of the front door;

FIG. 11 is a perspective view showing one example of another embodiment of the self checkout terminal in which an attachment structure of the front door is different from that of the self checkout terminal shown in FIGS. 1 to 10;

FIG. 12 is a side view showing the state where the front door starts opening in the attachment structure of the front door shown in FIG. 11; and

FIG. 13 is an exploded perspective view showing one of regulating boards attached to both edges of an opening of the settlement unit, and showing a magnet.

### DETAILED DESCRIPTION OF THE PREFERRED EMBODIMENTS

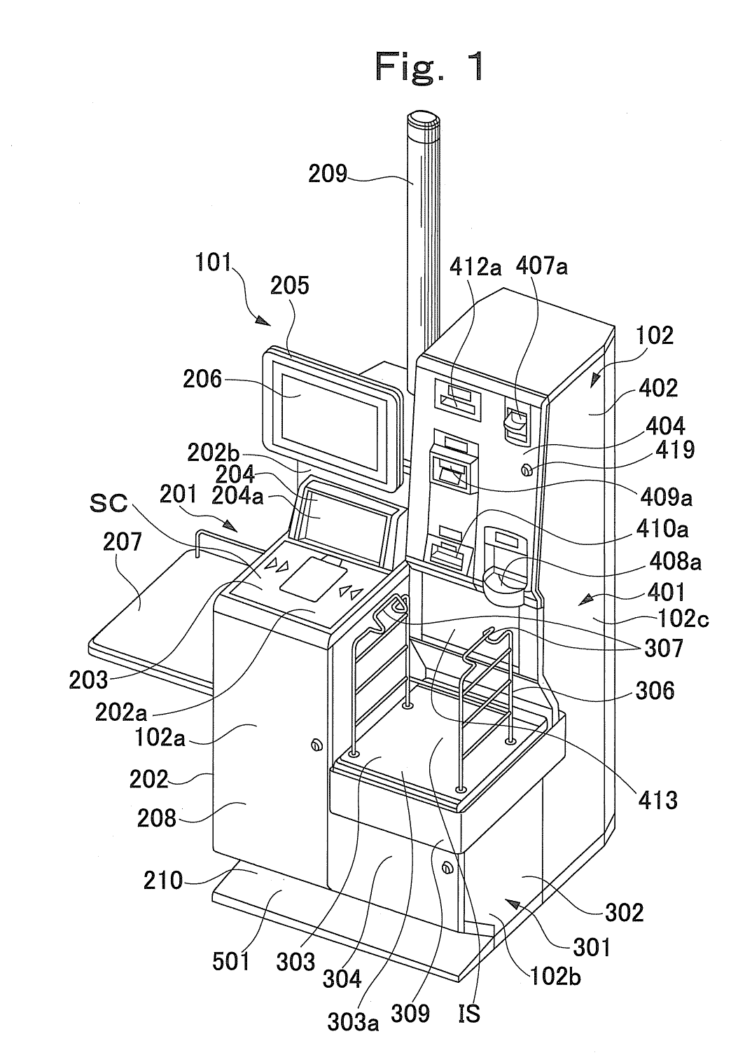

One embodiment of the present invention is explained based on FIGS. 1 to 10.

FIG. 1 is a perspective view showing a self checkout terminal 101. The self checkout terminal 101 collectively includes three units. The units include: a register unit 201, a weighting unit 301, and a settlement unit 401. These units are coupled to each other to form a single housing 102. The housing 102 collectively includes: a first block 102a forming the register unit 201 in which the width is shorter than the height and depth, and in which the front height is lower than the back height; a second block 102b formed of the weighting unit 301 which is arranged adjacent to the first block 102a such that their front faces are aligned, and which has a smaller height and depth than those of the first block 102a; and a third block 102c formed of the settlement unit 401 standing behind the second block 102b and having a height higher than the back height of the first block 102a.

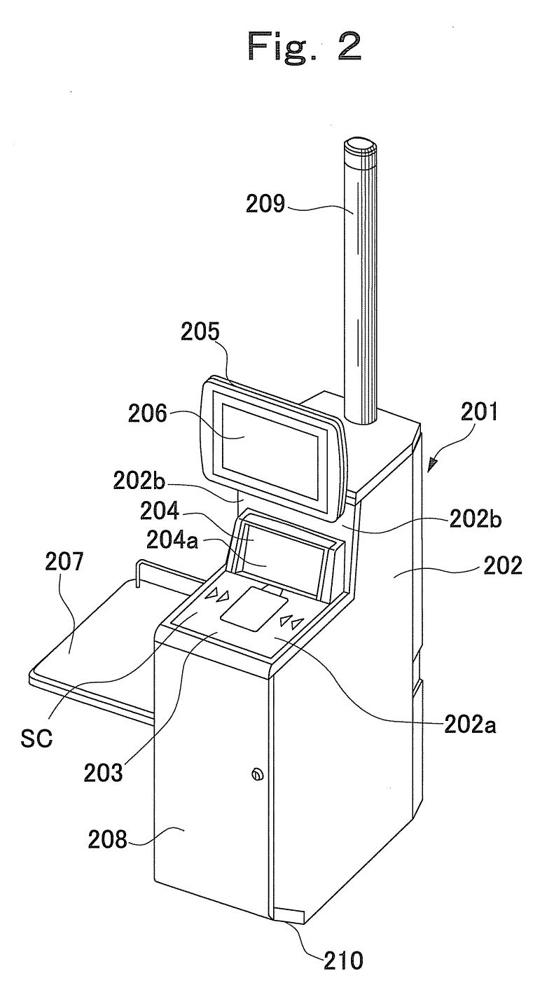

FIG. 2 is a perspective view of the register unit 201. The register unit 201 has a first housing 202 having a rectangular parallelepiped shape having a narrow width and large depth. In the first housing 202, a ratio of the width and depth is about 1:2, and the front height is lower than the back height. The front top surface of the housing 202 is a flat face 202a, which is horizontally arranged. The housing 202 rises behind the flat face 202a, so that the back height is higher than the front height. The rising surface from behind the flat face 202a is a front face 202b behind the flat face 202a.

The register unit 201 contains a scale SC having a weighting base 203 arranged to the flat face 202a on the front side of the first housing 202. The scale SC is used to weigh an item to be sold by weight mounted on the weighting base 203. A scanner 204 is arranged to the front face 202b behind the first housing 202. The scanner 204 has a reading face 204a, which has a flat glass shape. The scanner 204 optically reads a code symbol of an item in front of the reading surface 204a. A display 205 is arranged to the front face 202b behind the first housing 202 and above the scanner 204. The display 205 is, for example, a liquid crystal display whose display surface has a touch panel.

The register unit 201 has an item tray 207 on its left side. The item tray 207 is used for mounting an item to be purchased by a user.

The register unit 201 has a door 208 in its front face. A storage space (not shown) is provided behind the door 208.

A warning pole 209 stands on the higher back top surface of the register unit 201. The warning pole 209 reports the occurrence of an error by blinking at the time of the error of the self checkout terminal 101.

A front portion below the door 208 of the register unit 201 inclines such that a projected area viewed above the first housing 202 narrows downwardly. The first housing 202 is downwardly offset in the back. The offset portion of the register unit 201 is used as a foot space 210, which is offset in the back. The foot space 210 functions as a foot space for users using wheelchairs.

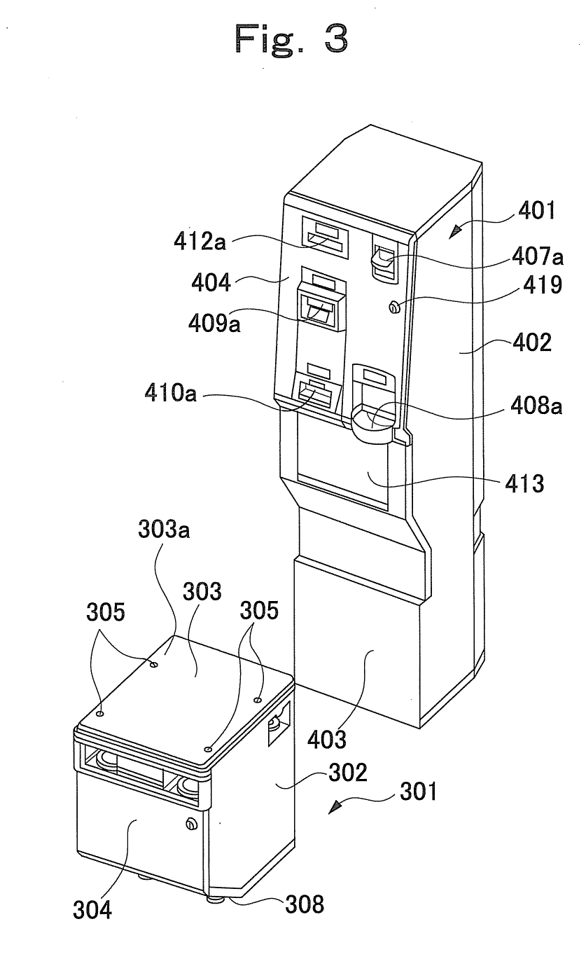

FIG. 3 is a perspective view showing a weighting unit 301 and a settlement unit 401.

The weighting unit 301 has a second housing 302 having an approximately rectangular parallelepiped shape. The second housing 302 has an about half depth relative to the depth of the first housing 202 of the register unit 201. The second housing 302 has an about half height relative to the height of the flat face 202a on the front side of the first housing 202.

The second housing 302 of the weighting unit 301 contains a weighting device 303 on which a weighting base 303a is arranged. The weighting device 303 weighs an item whose product code has been read by the scanner 204, and determines whether the weight of an item on the weighting device 303 matches the weight of the item whose product code has been read. The weighting device 303 is used for the weight check.

The weighting unit 301 also contains a controller (not shown) structured by a computer, the controller controlling each section of the self checkout terminal 101. The second housing 302 of the weighting unit 301 has a door 304 on the front face of the second housing 302. By opening the door 304, the controller can be detached and attached.

Attachment holes 305 are formed to four corners of the weighting base 303a. The attachment holes 305 are used for attaching a bagging frame 306 to which an item bag (not shown) for containing purchased items is set (see FIG. 1). As shown in FIG. 1, the bagging frame 306, formed by bending and welding multiple wires, is attached to the weighting base 303a. A pair of hook portions 307 for hooking a pair of handles (not shown) of an item bag and for keeping the bag open are provided to upper portions of the both sides of the bagging frame 306. An area between the hook portions 307 defines an item mounting space IS where the item bag containing items whose code symbols have been read by the scanner 204 is arranged. The item mounting space IS is secured above the weighting base 303a of the weighting unit 301.

The front portion below the door 304 of the weighting unit 301 inclines such that a projected area viewed from above the second housing unit 302 narrows downwardly. The second housing 302 is offset in the back toward the bottom. The offset portion of the weighting unit 301 is a foot space 308 offset in the back. The foot space 308 functions as a foot space for users using wheelchairs.

The settlement unit 401 has a third housing 402 having a tall rectangular parallelepiped shape. The third housing 402 has the same width as that of the second housing 302 of the weighting unit 301. A connection face 403 formed to the lower portion of the front face of the third housing 402 is connected to the back face of the weighting unit 301. A depth of the third housing 402 is set such that the depth of the weighting unit 301 and settlement unit 401 connected to one another substantially matches the depth of the register unit 201. The third housing 402 does not have a perfect rectangular parallelepiped shape, but has a shape in which the connection face 403 is offset in the back. As shown in FIG. 1, when the third housing 402 is arranged adjacent to the register unit 201, a front panel 404 provided to the front upper portion of the third housing 402 is arranged alongside the scanner 204 and display 205 provided to the register unit 201. The front face of the front panel 404 is not vertical, but upwardly inclines in the back. A height of the third housing 402 is higher than the height of the back portion of the first housing 202 of the register unit 201, and lower than the height of the warning pole 209.

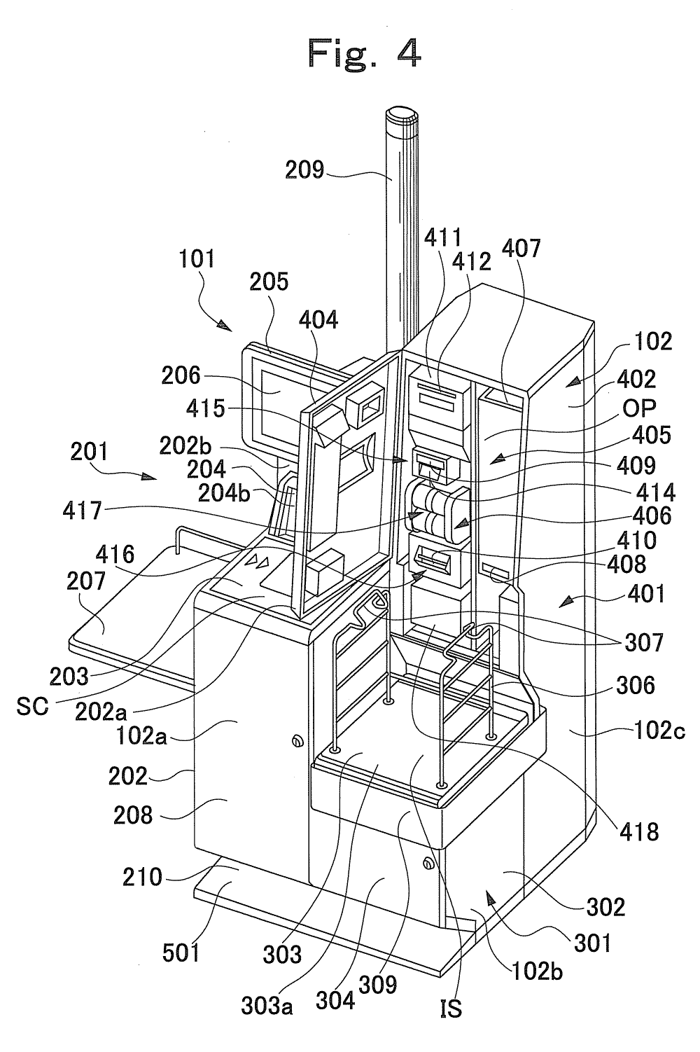

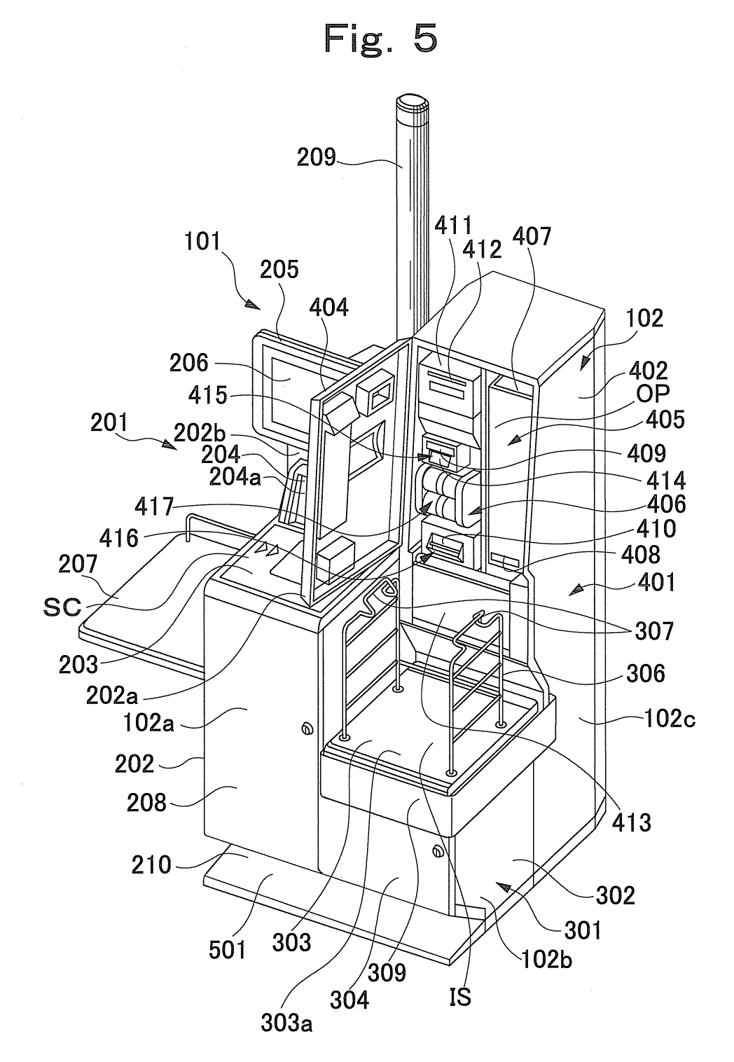

The settlement unit 401 contains cash dispenser modules in the third housing 402. The cash dispenser modules include a coin dispenser module 405 (see FIGS. 4 and 5) for coins and a bill dispenser module 406 (see FIGS. 4 and 5) for bills. The coin dispenser module 405 has a coin inlet 407 and a coin outlet 408, and the bill dispenser module 406 has a bill inlet 409 and a bill outlet 410 (see FIG. 4 and FIG. 5). Communication openings 407a, 408a, 409a, and 410a respectively communicating with the coin inlet 407, coin outlet 408, bill inlet 409, and bill outlet 410 are provided to the front panel 404. The communication opening 407a communicating with the coin inlet 407 is arranged to the right upper portion of the front panel 404. The communication opening 408a communicating with the coin outlet 408 is arranged to the right lower portion of the front panel 404. The communication opening 409a communicating with the bill inlet 409 is arranged to the left upper portion of the front panel 404. The communication opening 410a communicating with the bill outlet 410 is arranged to left lower portion of the front panel 404.

The third housing 402 of the settlement unit 401 contains a receipt printer 411 (see FIGS. 4 and 5). A communication opening 412a communicating with a receipting opening 412 (FIGS. 4 and 5) of the receipt printer 411 is provided to the front panel 404. The communication opening 412a is arranged higher than the communication opening 410a communicating with the bill outlet 410 at the left upper portion of the front panel 404.

FIG. 4 is a perspective view of the self checkout terminal 101 in which the front panel 404 and front door 413 (see FIGS. 1 and 5, etc.) of the settlement unit 401 are opened. The front face of the third housing 402 forming the settlement unit 401 is an opening OP. The front panel 404 is pivotally attached to the opening OP about the vertical axis to be openable and closable. In such a structure, the front panel 404, which pivots to open, is attached at a height at which the pivot of the front panel 404 does not interfere with the bagging frame 306 attached to the weighting base 303a of the weighting unit 301. On the other hand, the opening OP of the third housing 402 is provided extending near the top face of the weighting base 303a of the weighting unit 301. Accordingly, the opening OP of the third housing 402 cannot be completely covered solely with the front panel 404.

FIG. 5 is a perspective view of the self checkout terminal 101 in which only the front panel 404 of the settlement unit 401 is opened. Since the opening OP of the third housing 402 cannot be covered solely with the front panel 404 completely, a front door 413 is attached to the third housing 402 to cover the portion of opening OP not covered with the front panel 404. The front door 413 is provided below the front panel 404 to be openable and closable without interfering with the bagging frame 306.

As shown in FIGS. 4 and 5, the coin dispenser module 405 is on the right side of the third housing 402, and is arranged to the position covered only with the front panel 404. The coin dispenser module 405 has the coin inlet 407 on its upper end, and has the coin outlet 408 on its lower end. The coin dispenser module 405 is attached to the third housing 402 to be able to be drawn to the near side. As the coin dispenser module 405, a vertical recycle type is used.

As shown in FIGS. 4 and 5, the bill dispenser module 406 is arranged to the left side of the third housing 402. The bill dispenser module 406 includes: a bill inlet unit 415 having the bill inlet 409 and a liquid crystal display section 414; a bill outlet unit 416 having the bill outlet 410; a recycling warehouse 417; and a safe 418. The bill inlet unit 415, recycling warehouse 417, bill outlet unit 416, and safe 418 are arranged in this order from the top. The bill inlet unit 415 and recycling warehouse 417 are arranged to the portion covered only with the front panel 404. The bill outlet unit 416 is arranged to the position covered with both the front panel 404 and front door 413. The safe 418 is arranged to the position covered only with the front door 413. The recycling warehouse 417 and safe 418 of the bill dispenser module 406 are attached to the third housing 402 to be able to be drawn to the near side. As the bill dispenser module 406, a vertical recycle type is used.

A lock 419 is provided to the front panel 404 of the settlement unit 401. The front panel 404 can be locked by a key (not shown). When the front panel 404 is opened, the front door 413 also can be opened. When the front panel 404 is opened, the cash dispenser modules (the coin dispenser module 405, the bill dispenser module 406) included in the settlement unit 401, and the receipt printer 411 also are opened, and maintained easily. At this time, the whole of the coin dispenser module 405 and the recycling warehouse 417 of the bill dispenser module 406 can be pulled out to the near side. The safe 418 of the bill dispenser module 406 can be pulled out to the near side by opening the front door 413.

FIG. 6 is an enlarged perspective view showing the state where the front door 413 of the settlement unit 401 is opening or closing. The front door 413 is attached to the third housing 402 to be able to move vertically and to be retained at a position covering the opening OP of the settlement unit 401 to be capable of position holding. The front door 413 is provided to the third housing 402 to be openable and closable by a vertical motion structure MM for supporting the front door 413 so that the front door 413 is free to move vertically and a supporting structure SM for supporting the closed front door 413 at the closed position.

As the vertical motion structure MM, retention grooves 420 having long holes are formed longitudinally along both side edges of the front door 413. Hook grooves 421 are formed to the substantially center portions of the both sides of the front door 413.

As the supporting structure SM, a pair of retention pins 422 fitting in a pair of the retention grooves 420 and a pair of hook pins 423 hooking a pair of hook grooves 421 are provided to the third housing 402. The retention pins 422 are arranged near the lower ends of the retention grooves 420 of the front door 413 in the state in which the front door 413 covers the opening OP of the third housing 402. The hook pins 423 are arranged to hook the hook grooves 421 of the front door 413 in the state in which the front door 413 covers the opening OP of the third housing 402.

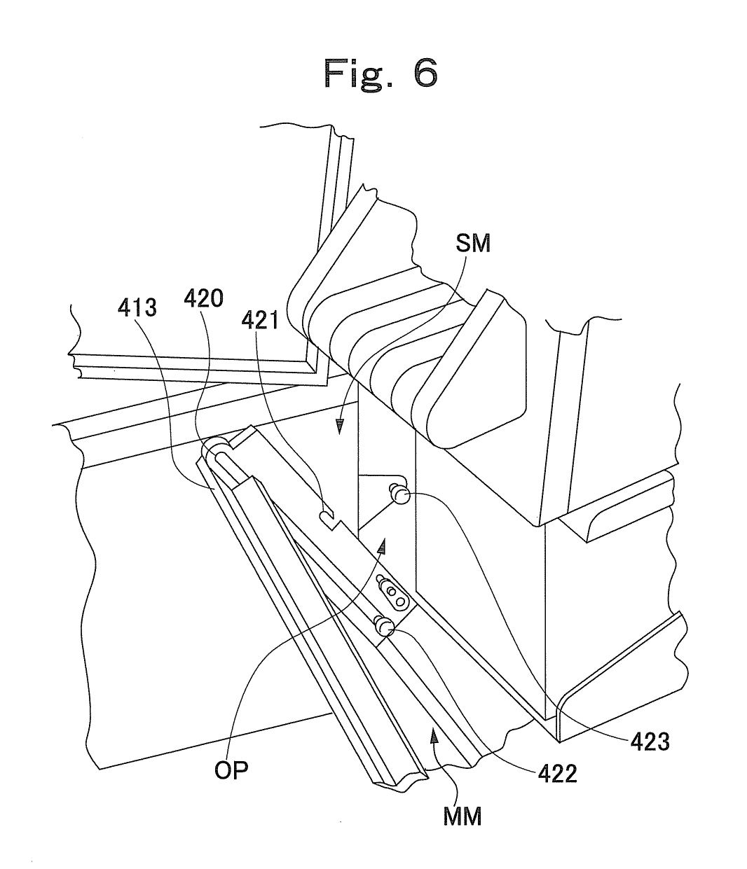

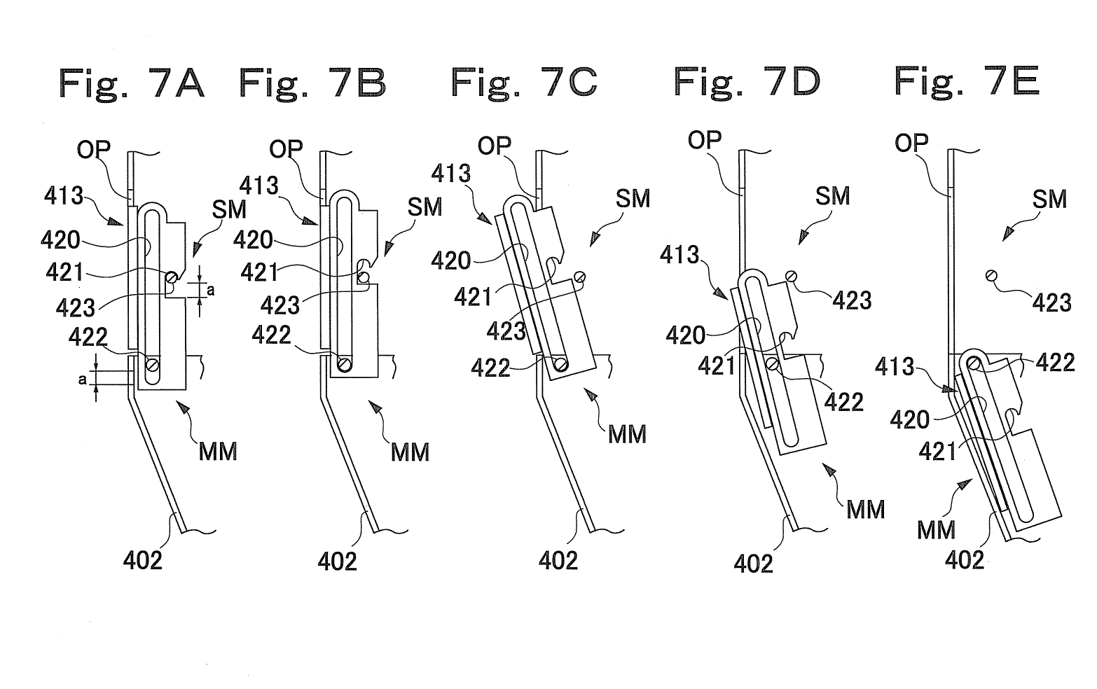

FIGS. 7A to 7E show the process of the transfer from the state in which the front door 413 of the settlement unit 401 is closed in FIG. 7A to the state in which the front door 413 is opened in FIG. 7E. FIGS. 7A to 7E show the state in which the heads of the retention pins 422 and hook pins 423 are cut. As shown in FIG. 7A, the hook grooves 421 are hooked by the hook pins 423 provided to the third housing 402, so that the front door 413 is retained at a position covering the opening OP. In this state, each of the hook grooves 421 secures a stroke of a below the hook groove 421. Each of the retention grooves 420 secures a stroke of a below the retention groove 420. Therefore, the front door 413 retained at the position covering the opening OP can be moved upward by the stroke of a.

The front panel 404 is arranged above the front door 413.

Each portion is arranged such that the front door 413 strikes on the lower end of the front panel 404 before the front door 413 moves by the stroke of a, when the front door 413 is to raised in the state in which the front panel 404 is closed. Accordingly, the front door 413 cannot be opened in the state in which the front panel 404 is closed.

When the front panel 404 is opened, the front door 413 can be raised by the stroke of a. FIG. 7B shows this state. When the upper portion of the front door 413 is moved in the near side from the state shown in FIG. 7B, the front door 413 pivots about the retention pins 422 to remove the hook grooves 421 from the hook pins 423. FIG. 7C shows this state. In the state of FIG. 7C, the front door 413 can move downward. In this case, the front door 413 can move downward by a stroke by which the retention pins 422 can move in the retention grooves 420. FIG. 7D shows the process during which the front door 413 moves downward. FIG. 7E shows the state in which the front door 413 fully moves downward.

As shown in FIGS. 1, 3, 4, and 5, the lower portion of the opening OP of the third housing 402 inclines in the back and is offset. FIGS. 7D and 7E, the front door 413 moves downward, and retained along the inclination of the third housing 402.

When the front door 413 is opened and closed relative to the opening OP of the third housing 402, the upper portion of the front door 413 pivots to the slightly near side. An amount of the pivot of the front door 413 is defined not to reach the position of the bagging frame 306. Accordingly, the front door 413 can be opened and closed freely relative to the third housing 402 without interfering with the bagging frame 306.

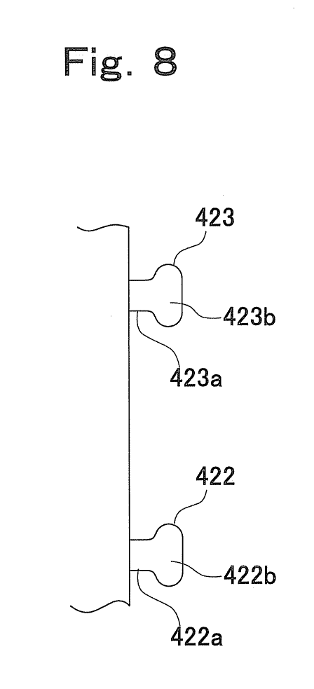

FIG. 8 is a front view showing shapes of the retention pin 422 and hook pin 423 forming part of the vertical motion structure MM and supporting structure SM provided to the portion to which the front door 413 of settlement unit 401 is attached. The retention pin 422 has a large diameter portion 422b, which is a head portion and provided to the top of a small diameter portion 422a fitting in the retention groove 420. The hook pin 423 has a large diameter portion 423b, which is a head portion and provided to the top of a small diameter portion 423a fitting in the hook groove 421.

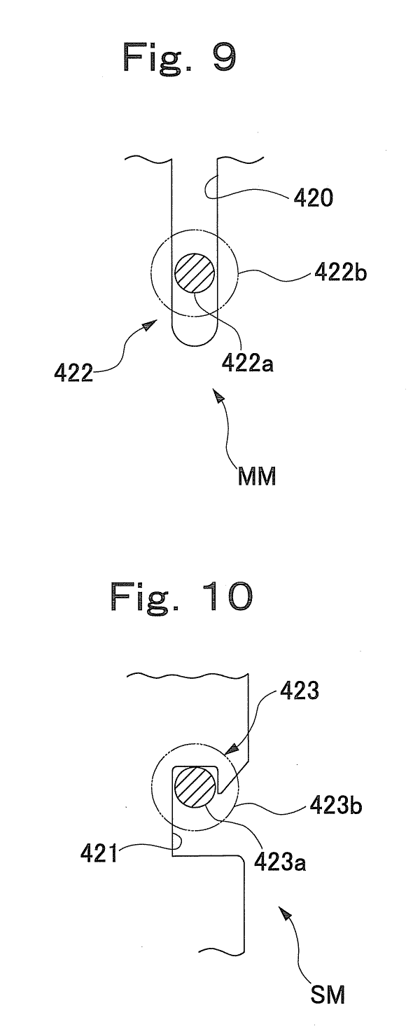

FIG. 9 is an enlarged side view showing the vertical motion structure MM of the front door 413. As shown in FIG. 9, the small diameter portion 422a of the retention pins 422 has a diameter that fits in the retention groove 420, and the large diameter portion 422b has a larger diameter than the groove width of the retention groove 420. Therefore, the retention pin 422 is prevented from falling from the retention groove 420 by use of the large diameter portion 422b.

FIG. 10 is an enlarged side view showing the supporting structure SM of the front door 413. As shown in FIG. 10, the small diameter portion 423a of the hook pin 423 has a diameter fitting in the hook groove 421, and the large diameter portion 423b has a larger diameter than the groove width of the hook groove 421. Therefore, the hook pin 423 is prevented from falling from the hook groove 421 by the large diameter portion 423b.

FIG. 1 is referenced again here. The self checkout terminal 101 includes: the weighting unit 301 arranged to the right side of the register unit 201; and the settlement unit 401 arranged behind the weighting unit 301. The front surfaces of the register unit 201 and weighting unit 301 are arranged alongside one another. The settlement unit 401 is arranged so that the connection face 403 is in contact with the back face of the weighting unit 301. In this state, the register unit 201, weighting unit 301, and settlement unit 401 are coupled and fixed to each other. The connecting and fixing are achieved by the typical connection structure such as fasteners (not shown) including bolts and nuts. As the connection structure of the register unit 201 and weighting unit 301, a foot rest 501 is used. The foot rest 501 is a plate-like member for connecting the foot space 210 of the register unit 201 and the foot space 308 of the weighting unit 301 to each other continuously. The foot rest 501 has a shape whose front portion has a lower height and whose height increases toward the back. The height of the foot rest 501 is set such that the function of the foot space 210 of the register unit 201 and the foot space 308 of the weighting unit 301, namely, the function for providing the space into which the feet of a user using a wheelchair, is not spoiled.

A metal belt-like guard 309 is wound around the upper portion of the weighting unit 301, for example. The guard 309 protects the weighting unit 301 from shock applied from the outside. In design, the guard 309 generates the sense of togetherness as if the self checkout terminal 101 is formed by the single housing 102.

As shown in FIG. 1, the self checkout terminal 101 generates the sense of togetherness as if the self checkout terminal 101 is formed by the single housing 102. The self checkout terminal 101 includes different units: the register unit 201; weighting unit 301; and settlement unit 401. The flexible combination is possible. For example, the item base 207 is attached to the right side of the register unit 201, so that the weighting unit 301 and settlement unit 401 can be arranged to the left side of the register unit 201. As shown in FIG. 1, an item to be purchased is moved from left to right, and registered. By changing the layout, an item to be purchased can be moved from right to left, and registered.

In such a structure, the customer, or the user, puts items to be purchased into a shopping bag prepared by a shop, and places the bag on the item base 207. Then, the items are registered by the register unit 201. A controller (not shown) contained in the weighting unit 301 declares the start of one trade by use of the touch panel 206 in accordance with the instruction displayed on the display 205. Then, each item is taken out of the shopping bag on the item base 207, and a symbol code such as a barcode of the item is placed before the reading face 204a of the scanner 204, and the item code is read. Then, the controller retrieves a price and a weight corresponding to the item code read by the scanner 204 from an item data file (not shown) storing prices and weights corresponding to item codes. In this case, an item to be sold by weight is placed on the weighting base 203 of the scale SC contained in the register unit 201, and weighed. A price of the item is found in accordance with the retrieved price and weight. After the scanner 204 reads the item code, it is determined whether a weight outputted from the weighting device 303 contained in the weighting unit 301 matches the weight obtained by the retrieval or the weight obtained by the scale SC. Only in case of match, the item information registration is done in which item information including the read item code and the retrieved price is stored in a storage portion (not shown).

After reading item codes of all the items to be purchased, the controller declares the completion of one trade by use of the touch panel 206 in accordance with the instruction displayed on the display 205. The controller displays a settlement method using the settlement unit 401 on the display 206. In the settlement method in the settlement unit 401, cash settlement is done using the dispenser modules (coin dispenser module 405 and bill dispenser module 406). Then, in accordance with the guidance displayed on the display 205, the user puts bills into the bill inlet 409 communicating with the communication opening 409a, and coins into the coin inlet 407 communicating with the communication opening 407a. If necessary, the user receives change from the bill output 410 communicating with the communication opening 410a and from the coin outlet 408 communicating with the communication opening 408a. Finally, the controller controls the receipt printer 411 contained in the settlement unit 401 to print a receipt (not shown), and issues the receipt from the receipting opening 412 communicating with the communication opening 412a. The customer, or the user, receives the receipt, and completes one trade.

The self checkout terminal 101 of this embodiment achieves both high operability and downsizing of the whole device. This is explained below.

First, the high operability is explained. Viewed from the user, the display 205 having the touch panel 206 is arranged in the back of the scanner 204. The movement of the eyes and hands in the item registration can be minimized. The eyes and hands move only when the user moves items mounted on the item base 207 by hands through before the scanner 204 onto the weighting base 303a of the weighting unit 301.

In other cases, the information provision for the user and the operations by the user are integrated into the area of the display 205 having the touch panel 206, so that the eyes and hands do not move in the right and left directions. According to this embodiment, the integration of operations for the item registration is done in the register unit 201, so that high operability can be achieved. The items need to be once raised on the weighting base 203 at the register unit 201 to read code symbols of the items by use of the scanner 204. On the other hand, at the weighting unit 301, the weighting base 303a, on which the items whose code symbols have been read are mounted sequentially, is lower than the weighting base 203 of the register unit 201. The maximum mounting height of items in the item mounting space IS formed on the mounting base 303a roughly matches the height of the weighting base 203 of the register unit 201. The item raised on the weighting base 3 does not need to be raised further to be mounted on the weighting base 303a of the weighting unit 301. Therefore, the items whose code symbols have been read can be mounted on the weighting base 303a smoothly, so that high operability can be obtained. The settlement after the registration of items is done only at the settlement unit 401, so that the eyes and hands do not move in the right and left directions. According to this embodiment, the operations for the settlement are integrated into the settlement unit 401 which is arranged in the back of the weighting unit 301 and whose operation face is arranged above the item mounting space IS, so that high operability can be obtained. According to the self checkout terminal 101 of this embodiment, high operability can be provided.

The downsizing of the whole device is explained. The self checkout terminal 101 of this embodiment has the vertical recycle type coin dispenser module 405 and bill dispenser module 406 arranged alongside to one another and contained in the settlement unit 401. The width of the settlement unit 401 can be made small. The weighting unit 301 and settlement unit 401 are arranged alongside one another in the register unit 201. Further, the weighting unit 301 and settlement unit 401 are arranged in the back direction viewed from the user, so that the whole width can be made small. The downsizing of the whole of the self checkout terminal 101 of this embodiment can be realized.

The maintenance of the settlement unit 401 and the supplement and collection of cash of the dispenser modules (coin dispenser module 405, bill dispenser module 406) are explained. The front panel 404 is opened to do these operations. In this case, the front door 413 is also opened if needed. By unlocking the lock 419 by use of the key (not shown), the front panel 404 can be opened by pivoting about the vertical axis. in this state, the front door 413 also can be opened in the procedure shown in FIG. 7. The opening OP of the third housing 402 is fully opened, so that the maintenance and the supplement and collection of cash can be done.

The maintenance etc. of the settlement unit 401 is considered from another view. The bagging frame 306 attached to the weighting base 303a of the weighting unit 301 defines the item mounting space IS in the self checkout terminal 101 of this embodiment. As described above, the item mounting space IS and its position play a major role in achieving both the high operability and downsizing of the whole device. The coin dispenser module 406 and bill dispenser module 406, which are the dispenser modules for coins and bills, use the vertical recycle type and are arranged alongside one another in the settlement unit 401, so that the width of the settlement unit 401 is made small. Since the coin dispenser module 406 and bill dispenser module 406 are arranged alongside one another, the bagging frame 306 becomes an obstacle when the maintenance and the supplement and collection of cash are to made easy in the full open structure of the settlement unit 401. According to this embodiment, the pivoting of the front panel 404 covering the opening OP formed to the front face of the third housing 402 of the settlement unit 401 does not interfere with the bagging frame 306. The area of the opening OP which cannot be covered with the front panel 404 is covered with the front door 413 openable and closable without interfering with the bagging frame 306. High operability for the maintenance and the supplement and collection of cash in the settlement unit 401 can be achieved.

The sense of togetherness as if the register unit 201, weighting unit 301, and settlement unit 401 are structured by the single housing 102, is obtained in the self checkout terminal 101 of this embodiment. Such a sense of togetherness is based on each appearance and layout of each of the register unit 201, weighting unit 301, and settlement unit 401. Because of the appearances and layouts of the units, the housing 102 looks like one body collectively including: the first block 102a having a smaller width than its height and depth, and having a front height lower than its back height; the second block 102b whose front face is aligned with the front face of the first block 102a and which is arranged alongside the first block 102a, the second block 102b having a smaller height and depth than those of the first block 102a; and the third block 102c rising behind the second block 102b and being higher than the back side of the first block 102a. The units look like a structure of the single housing 102.

According to the self checkout terminal 101 of this embodiment, the register unit 201, weighting unit 301, and settlement unit 401 look like a structure of the single housing 102. However, each unit has a high degree of freedom of the layout. As described above, in the self checkout terminal 101, the item base 207 is attached to the right side of the register unit 201, so that the weighting unit 301 and settlement unit 401 can be also arranged to the left side of the register unit 201.

As shown in the example of FIG. 1, the item to be purchased is moved from left to right to register the item. In contrast, by changing the layout, the item to be purchased can be moved from right to left to register the item.

The front panel 404 of the settlement unit 401, namely, the front face of the third block 102c, upwardly inclines in the back.

Accordingly, the user feels less pressure compared to the case in which the front panel 404 stands vertically.

The lower portions of the front faces of the register unit 201 and weighting unit 301, namely, the lower portions of the front faces of the first block 102a and second block 102b, are used as the foot spaces 210 and 308 offset in the back. When the user using a wheelchair faces the self checkout terminal 101, the feet of the user can be placed in the foot spaces 210 and 308, further improving the operability.

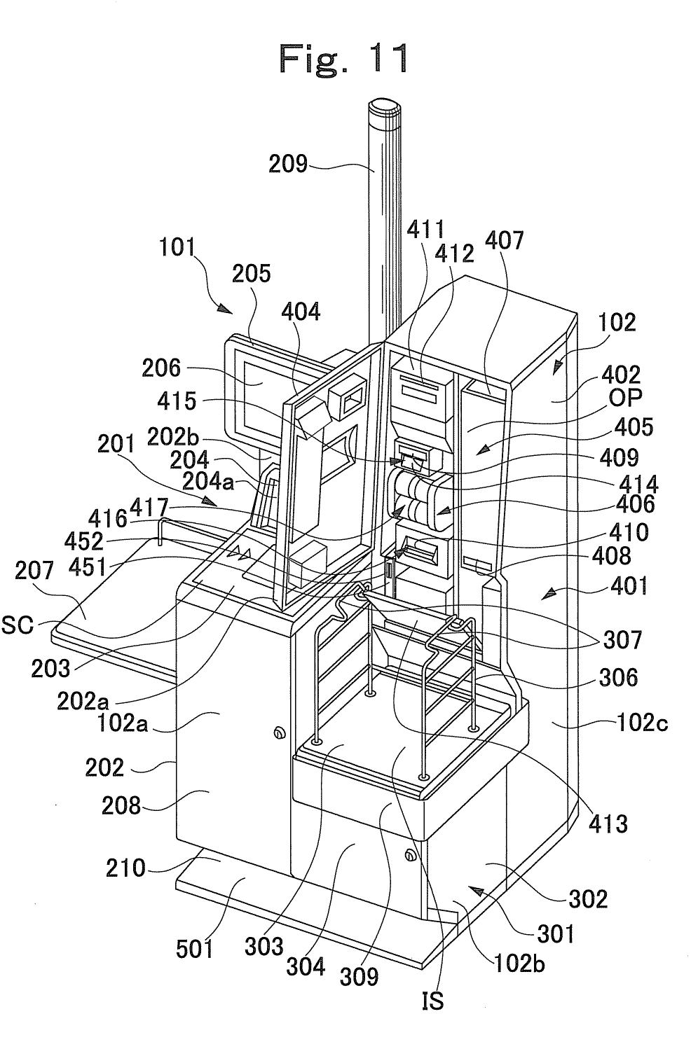

Another embodiment of the present invention is explained based on FIGS. 11 to 13. According to this embodiment, the attachment structure of the front door 413 is different from that of the self checkout terminal 101 shown in FIGS. 1 to 10. The front door 413 is openable and closable by a pivot structure RM for pivotally supporting the lower portion of the front door 413 about the longitudinal axis and a supporting structure SM for supporting the front door 413 at the closed state.

FIG. 11 is a perspective view showing another example of the self checkout terminal 101. The front door 413 is attached pivotally toward the user about the lower edge of the opening OP formed in front of the third housing 402 of the settlement unit 401. Because of such a structure, the front door 413 has a smaller width than that of the bagging frames 306 attached to the weighting base 303a of the weighting unit 301.

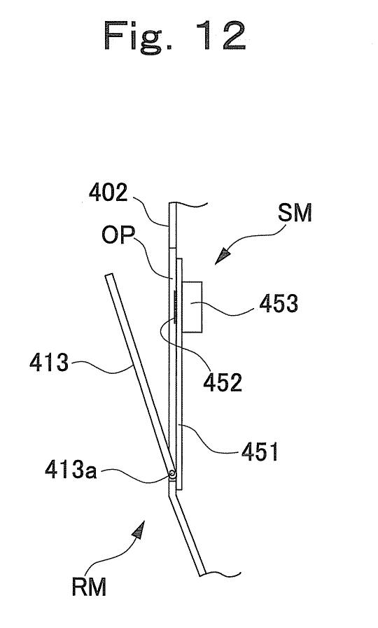

FIG. 12 is a side view showing the state where the front door 413 starts opening in the attachment structure of the front door 413 shown in FIG. 11. As the pivot structure RM, attachment shafts 413a project from both lower sides of the front door 413. The attachment shafts 413a are rotatably attached to both lower edges of the opening OP of the third housing 402. The front door 413 is pivotally attached to the opening OP. As the supporting structure SM, a pair of regulating boards 451 are attached to the both edges of the opening OP of the third housing 402, and arranged within the third housing 402. The regulating boards 451 abut the front door 413 at the position where the surface of the closed front door 413 and the front face of the third housing 402 share the same surface to regulate the position of the front door 413. A magnet 452 is attached to the upper portion of the regulating board 451. The magnet 452 attracts the front door 413 made of a metal plate to keep the front door 413 in the closed state.

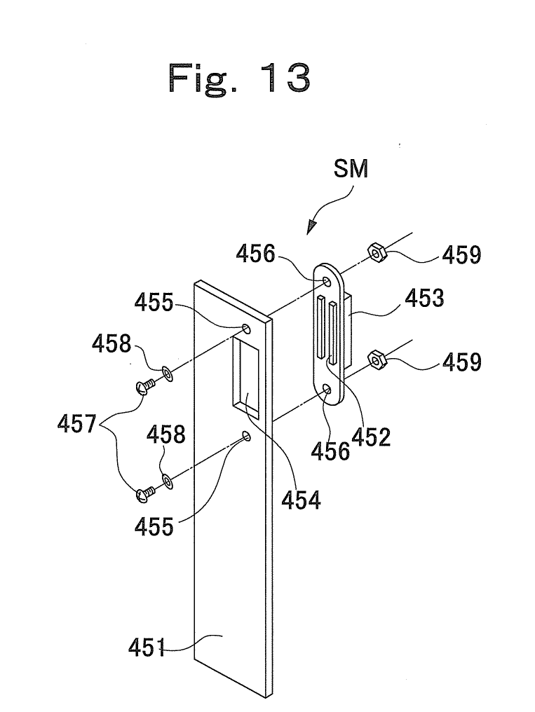

FIG. 13 is an exploded perspective view of one of the regulating boards 451 attached to the both edges of the opening OP of the settlement unit 401, and of the magnet 452. The magnet 452 projects from the front surface of a magnet holder 453 made of, e.g., resin in the form of two threads arranged adjacent to one another. The magnet holder 453 is attached to the regulating board 451 to expose only the magnet 452 from an exposure hole 454 formed to the regulating board 451. Two screw holes 455 are vertically formed to the regulating board 451, and two screw holes 456 are vertically formed to the magnet 452. A pair of screw threads 457 are inserted into the screw holes 455 of the regulating board 451 and into the screw hole 456 of the magnet 452 via washers 458, and screwed in bolts 459 on the back face of the magnet 452. In this way, the magnet 452 is fixed to the regulating board 451.

In such a structure, in the maintenance of the settlement unit 401 and the supplement and collection of cash in the dispenser module for coins and bills (coin dispenser module 405, bill dispenser module 406), the front door 413 can be opened by opening the front panel 404.

When the front door 404 is opened, the user can put the hand on the upper end of the front door 413. By pivoting the upper portion of the front door 413 in the near side, the front door 413 can be opened. At this time, when the front door 413 is pivoted to the near side by the force exceeding the magnetic attraction of the front door 413 by the magnet 452, the front door 413 pivots easily.

Obviously, numerous modifications and variations of the present invention are possible in light of the above teachings. It is therefore to be understood that within the scope of the appended claims, the invention may be practiced otherwise than as specifically described herein.

What is claimed is:

1. A self checkout terminal comprising:
a register unit having a scanner that reads a code symbol of an item optically and a display having a touch panel;
a weighting unit having a smaller height and depth than those of the register unit, being able to be arranged alongside register unit, and having a weighting device for checking a weight, in which a mounting base is arranged to a top of the weighting device, an item whose code symbol has been read by the scanner is mounted on the mounting base, and an item mounting space is secured to position the item in a state in which the item is packed in a bag;
a settlement unit having a same width as the weighting unit and being higher than the weighting unit, being able to be arranged alongside the register unit behind the weighting unit, and having a coin dispenser module and a bill dispenser module arranged alongside one another, the devices being a vertical recycle type;
a bagging frame being attached to the weighting base of the weighting unit, having a pair of hook portions opposed to one another to keep open an item bag storing the item whose code symbol has been read by hooking a pair of handles of the item bag, and defining an area between the hook portions as the item mounting space;
a front panel being pivotally attached to be openable and closable about a vertical axis at a height that does not interfere with the bagging frame in front of the settlement unit, having communication openings respectively communicating with a coin inlet and a coin outlet of the coin dispenser module and with a bill inlet and a bill outlet of the bill dispenser module, and exposing the coin dispenser module and the bill dispenser module to an outside when the front panel is opened; and
a front door provided to a lower position of the front panel on a front face of the settlement unit without interfering with the bagging frame, the front door being openable and closable, and exposing at least one of the coin dispenser module and the bill dispenser module when the front door is opened.

2. The self checkout terminal according to claim 1, wherein the coin dispenser module is provided to be able to be drawn from the settlement unit in a state in which the front panel is opened.

3. The self checkout terminal according to claim 1, wherein:
part of the bill dispenser module is provided to be able to be drawn from the settlement unit in a state in which the front panel is opened; and
the other part of the bill dispenser module is provided to be able to be drawn from the settlement unit in a state in which the front door is opened.

4. The self checkout terminal according to claim 2, wherein:
part of the bill dispenser module is provided to be able to be drawn from the settlement unit in a state in which the front panel is opened; and
the other part of the bill dispenser module is provided to be able to be drawn from the settlement unit in a state in which the front door is opened.

5. The self checkout terminal according to claim 1, wherein:
the settlement unit contains a receipt printer having a receipting opening arranged above a height at which the bagging frame in front of the settlement unit is arranged; and
the front panel includes a communication opening communicating with the receipting opening of the receipt printer.

6. The self checkout terminal according to claim 5, wherein the receipt printer is arranged above the coin dispenser module.

7. The self checkout terminal according to claim 5, wherein the receipt printer is arranged above the bill dispenser module.

8. The self checkout terminal according to claim 1, further comprising:
a vertical motion structure for supporting the front door such that the front door is able to vertically move; and
a supporting structure for supporting the front door in a closed state at a closed position.

9. The self checkout terminal according to claim 1, further comprising:
a pivot structure for supporting a lower portion of the front door pivotally about a horizontal axis; and
a supporting structure for supporting the front door in a closed state at a closed position.

10. The self checkout terminal according to claim 1, wherein a ratio of a width and a depth of the register unit is set to 1:2.

11. The self checkout terminal according to claim 1, wherein a depth of the register unit is identical with a depth of both the weighting unit and the settlement unit.

12. The self checkout terminal according to claim 10, wherein a depth of the register unit is identical with a depth of both the weighting unit and the settlement unit.

13. The self checkout terminal according to claim 10, wherein the scanner is arranged to a back side of an upper portion of the register unit, and the display is arranged above the scanner.

14. The self checkout terminal according to claim 13, wherein a flat face is horizontally arranged at an upper portion of a front side of the register unit, and contains a scale in which a weighting base is arranged to the flat face.

15. The self checkout terminal according to claim 14, wherein the height of the weighting base of the register unit is identical with a maximum mounting height of an item in the item mounting space formed above the weighting base of the weighting unit.

16. The self checkout terminal according to claim 1, wherein a front face of the settlement unit upwardly inclines in a back.

17. A method for installing a self checkout terminal comprising:
a step for installing a register unit, the register unit including a scanner for reading a code symbol of an item optically and a display having a touch panel;
a step for installing a weighting unit having a smaller height and depth than the register unit alongside the register unit;
the weighting unit comprising:
a weighting device for checking a weight, in which a weighting base is arranged on a top face of the weighting device, an item whose code symbol has been read is mounted on the weighting base, and an item mounting space is secured above the weighting base to position the item whose code symbol has been read in a state in which the item is packed in a bag; and
a bagging frame being attached to the weighting base of the weighting unit, having a pair of hook portions arranged opposing to one another to keep an item bag containing the item open by hooking a pair of handles of the bag, and defining an area between the hook portions as the item mounting space; and
a step for installing, alongside the register unit behind the weighting unit, a settlement unit having a same width as the weighting unit and a higher height than that of the weighting unit,
the settlement unit comprising:
a coin dispenser module and a bill dispenser module, which both are a vertical recycle type, and which are arranged alongside one another and contained in the settlement unit;
a front panel being pivotally attached to be openable and closable about a vertical axis at a height that does not interfere with the bagging frame in front of the settlement unit, having communication openings respectively communicating with a coin inlet and a coin outlet of the coin dispenser module and with a bill inlet and a bill outlet of the bill dispenser module, and exposing the coin dispenser module and the bill dispenser module to an outside when the front panel is opened; and
a front door provided to a lower position of the front panel on a front face of the settlement unit without interfering with the bagging frame, the front door being openable and closable, and exposing at least one of the coin dispenser module and the bill dispenser module when the front door is opened.

18. The method according to claim 17, wherein a ratio of a width and a depth of the register unit is set to 1:2.

19. The method according to claim 17, wherein a depth of the register unit is identical with a depth of both the weighting unit and the settlement unit.

20. The method according to claim 17, wherein the height of the weighting base of the register unit is identical with a maximum mounting height of an item in the item mounting space formed above the weighting base of the weighting unit.
